(19) United States
(12) Patent Application Publication
(10) Pub. No.: US 2024/0362661 A1
(43) Pub. Date: Oct. 31, 2024

(54) TECHNOLOGIES FOR ASSESSING DIGITAL OFFER PERFORMANCE BASED ON APPLICATION ACTIVITY

(71) Applicant: FETCH REWARDS, LLC, Chicago, IL (US)

(72) Inventors: James Wilkie, Highwood, IL (US); David Berk, Las Vegas, NV (US)

(21) Appl. No.: 18/140,525

(22) Filed: Apr. 27, 2023

(51) Int. Cl. G06Q 30/0211

(52) U.S. Cl. CPC G06Q 30/0211

(57) ABSTRACT

Systems and methods for assessing performance of a digital promotion associated with a product or service are disclosed. According to certain embodiments, the systems and methods may avail the digital promotion within an application operated by a set of treatment devices. Further, the systems and methods may determine which products or services are purchased by users of the set of treatment devices and by users of a set of control devices, and may assess a performance of the digital promotion based on information indicating the purchases by the treatment and control users. The systems and methods may additionally assess a return on investment metric of the digital promotion for a partner entity associated with the digital promotion.

### FIELD

The present disclosure is directed to systems and methods for assessing the performance of a digital promotion within a measurable and pre-determined environment. More particularly, the present disclosure is directed to platforms and technologies for analyzing data retrieved from electronic devices segmented into control and treatment groups to determine an effectiveness of a digital promotion that is availed to the treatment devices.

### BACKGROUND

Generally, it is important for marketing strategies of a company to lead to improved key performance indicators (KPIs), as KPIs are a measure of success and progress for a company in an effort towards achieving its goals. By tracking KPIs and optimizing marketing strategies to improve the KPIs, companies can make data-driven decisions to achieve their goals, improve their financial performance, and enhance customer satisfaction and loyalty.

Conventionally, versions of randomized controlled trials (RCTs) are used by companies for measuring the amount of impact that promotional activities have on KPIs. However, there are several drawbacks to the conventional use of RCTs. For example, conducting RCTs can be expensive and time-consuming to set up, execute, and analyze. Additionally, designing, implementing, and analyzing RCTs can be complex, among other drawbacks including internal resistance and/or inapplicability.

Accordingly, there is an opportunity for platforms and technologies to create and facilitate an environment including a plurality of electronic devices where the effects of promotional activities on company KPIs can be accurately, effectively, and successfully measured.

### SUMMARY

In an embodiment, a computer-implemented method of assessing performance of a digital promotion for a partner entity and associated with a product or service is provided. The computer-implemented method may include: segmenting, by at least one computer processor, a plurality of users into a control group that includes a first portion of the plurality of users and a treatment group that includes a remaining portion of the plurality of users, wherein a set of control devices is respectively associated with the first portion of the plurality of users and a set of treatment devices is respectively associated with the remaining portion of the plurality of users; availing, for a set period of time, the digital promotion within an application operated by each of the set of treatment devices, wherein the application indicates a reward associated with the digital promotion; accessing, by the at least one processor, (i) first information indicating whether the product or service was purchased, during the set period of time, by each of the first portion of the plurality of users respectively associated with the set of control devices, and (ii) second information indicating whether the product or service was purchased, during the set period of time and subject to the digital promotion, by each of the remaining portion of the plurality of users respectively associated with the set of treatment devices; calculating, by the at least one processor, a performance metric for the digital promotion based on the first information and the second information; and calculating, by the at least one processor, (i) a sales metric for the product or service that is attributable to the digital promotion, based on the performance metric, and (ii) a return metric based on the sales metric and a cost of the digital promotion.

In another embodiment, a system for assessing performance of a digital promotion for a partner entity and associated with a product or service is provided. The system may include a memory storing a set of computer-readable instructions, and one or more processors interfaced with the memory. The one or more processors may be configured to execute the set of computer-readable instructions to cause the one or more processors to: segment a plurality of users into a control group that includes a first portion of the plurality of users and a treatment group that includes a remaining portion of the plurality of users, wherein a set of control devices is respectively associated with the first portion of the plurality of users and a set of treatment devices is respectively associated with the remaining portion of the plurality of users, avail, for a set period of time, the digital promotion within an application operated by each of the set of treatment devices, wherein the application indicates a reward associated with the digital promotion, access (i) first information indicating whether the product or service was purchased, during the set period of time, by each of the first portion of the plurality of users respectively associated with the set of control devices, and (ii) second information indicating whether the product or service was purchased, during the set period of time and subject to the digital promotion, by each of the remaining portion of the plurality of users respectively associated with the set of treatment devices, calculate a performance metric for the digital promotion based on the first information and the second information, and calculate, by the at least one processor, (i) a sales metric for the product or service that is attributable to the digital promotion, based on the performance metric, and (ii) a return metric based on the sales metric and a cost of the digital promotion.

In a further embodiment, a non-transitory computer-readable storage medium configured to store instructions executable by one or more processors is provided, where the instructions may include: instructions for segmenting a plurality of users into a control group that includes a first portion of the plurality of users and a treatment group that includes a remaining portion of the plurality of users, wherein a set of control devices is respectively associated with the first portion of the plurality of users and a set of treatment devices is respectively associated with the remaining portion of the plurality of users; instructions for availing, for a set period of time, a digital promotion within an application operated by each of the set of treatment devices, wherein the application indicates a reward associated with the digital promotion; instructions for accessing (i) first information indicating whether the product or service was purchased, during the set period of time, by each of the first portion of the plurality of users respectively associated with the set of control devices, and (ii) second information indicating whether the product or service was purchased, during the set period of time and subject to the digital promotion, by each of the remaining portion of the plurality of users respectively associated with the set of treatment devices; instructions for calculating a performance metric for the digital promotion based on the first information and the second information; and instructions for calculating (i) a sales metric for the product or service that is attributable to the digital promotion, based on the performance metric, and (ii) a return metric based on the sales metric and a cost of the digital promotion.

### BRIEF DESCRIPTION OF THE FIGURES

FIG. 1 depicts an overview of components and entities associated with the systems and methods, in accordance with some embodiments.

FIG. 2 depicts an example signal diagram detailing the functionalities of the systems and methods, in accordance with some embodiments.

FIGS. 3A and 3B depict example user interfaces associated with an application that may be presented by a set of control devices, in accordance with some embodiments.

FIGS. 4A and 4B depict example user interfaces associated with an application that may be presented by a set of treatment devices, in accordance with some embodiments.

FIGS. 5A and 5B depict example user interfaces associated with an application that may be presented by a set of control devices and a set of treatment devices, in accordance with some embodiments.

FIG. 6 illustrates an example flow diagram of assessing performance of a digital promotion for a partner entity and associated with a product or service, in accordance with some embodiments.

FIG. 7 is an example hardware diagram of an electronic device and a server configured to perform various functionalities, in accordance with some embodiments.

### DETAILED DESCRIPTION

The present embodiments may relate to, inter alia, systems and methods for accurately and efficiently measuring performances of digital promotions using data retrieved from a set of electronic devices segmented into control groups and treatment groups. According to certain aspects, a server computer may avail a digital promotion associated with a product or service offered by a partner entity to treatment group devices and withhold availing the digital promotion to control group devices. The control group devices and the treatment group devices may transmit data indicating product or service purchases to the server computer, which may determine purchase activity, including that related to the product or service as specified by the digital promotion. Additionally, the server computer may perform certain analyses to determine performance metrics associated with the digital promotion, from which the partner entity may glean various insights.

Versions of randomized control trials (RCTs) are conventionally used for causal measurements within the scientific community, as they provide the type of controlled environment that is needed in order to isolate the level of impact that individual factors (typically referred to as “independent variables”) have on specific outcome metrics (typically referred to as “dependent variables”). The advantage that RCTs have over other methods is their ability to eliminate selection bias from influencing outcome metrics, as the experimental condition that participants ultimately receive is randomly determined and not based on any selective criteria such as individual preferences.

Generally, entities such as companies need to be able to accurately measure the amount of impact that their promotional activities have on their key performance indicators (KPIs). Perhaps more critically, the entities need to be able to measure how their promotional activities affect their KPIs not just at one point, but across all points of time when their businesses are operational.

Because RCTs are generally effective in isolating the level of impact that any one factor might have on an outcome variable, it would be beneficial for an entity to be able to run a RCT-based process so that it would be able to more accurately understand how much of the change in KPI performance after a promotion was initiated (e.g., sales) can be specifically attributed to the promotion itself instead of some other factors (e.g., a fluctuation in seasonal demand) that might also have played a role in changing KPI performance.

While entities generally understand the extra value that a RCT approach would provide them, these entities do not perform RCT methods when trying to track the level of benefit they receive from their promotional activities from one point in time to another. For this, entities conventionally use “quasi-experimental” methods to try to approximate these types of measurements, which are essentially techniques that attempt to make the data collected be more “RCT-like”. While the scientific community generally recognizes that causal estimates obtained from quasi-experimental methods are valid, their quality is inferior to those produced by RCTs. Therefore, it is generally advised to conduct a quasi-experiment only when circumstances make it too difficult or impossible to conduct an RCT.

Therefore, the predominant reason why entities do not conduct RCTs for this type of measurement is because circumstances make it either too difficult or impossible to do so. This is because RCTs require a number of factors to be present in order to be properly conducted. For example, in order for a company to conduct an RCT, the company must, amongst other reasons, (i) be able to randomly assign its customers to separate experimental conditions at the outset of the process, (ii) have enough power to ensure that these customers only receive that specific condition that they were randomly assigned to, and (iii) have the ability to accurately track each of these customer's subsequent behaviors so that the outcome measures (e.g., sales of the promoted item) can be accurately matched back to the individual customer and its experimental assignment. Therefore, there are many shortcomings associated with existing technologies related to measuring impact of promotional activities on KPIs.

It is generally considered impossible for entities to operate in an environment where each of these conditions can be satisfied, let alone operate in an environment that would allow for an RCT process to be operating on an indefinite basis. That is, entities generally (i) do not possess a complete list of their customer base that would be required in order to draw a random sample, (ii) do not know of every possible consumer that may or may not have been exposed to the promotion (i.e., consumers that were exposed to the promotion but were not yet in a customer base of a given entity), (iii) are unable to ensure that the random assignments that they provide to their customers are actually maintained (e.g., making sure that a customer in the treatment group is exposed to a promotion while also making sure that a user in the control group is not exposed), and/or (iv) are unable to track and distinguish the subsequent behavior of one customer versus another when measuring the outcome response (e.g., an inability to determine whether an individual who purchased an item is part of the treatment group, the control group, or neither). Even assuming that an entity can satisfy these conditions, it is often impossible that the entity could perform these actions indefinitely due to the dynamically-changing nature of its customer base, as over time, the entity attracts new customers and loses old customers.

According to embodiments, the present systems and methods represent improvements on existing technologies for measuring impact of promotional activities on KPIs. In particular, the systems and methods provide an environment in which the effects of promotional activities on an entity's KPIs can be successfully measured using a RCT approach in which valid and accurate short-term and long-term promotional causal estimates may be provided to partner entities on an indefinite basis. Additionally, any estimated benefits received by conducting a given promotion (e.g., level of sales a partner entity received by conducting the promotion, including any sales above and beyond the level of sales the partner entity would have received if the promotion was not conducted) is accurately matched to the cost the partner entity incurred by conducting the promotion.

According to certain aspects, the systems and methods maintain a listing of users of the platform, where the platform environment may be closed such that the users are exposed to partner promotions (i.e., those users that receive a given partner promotion is the population that is measured). This is in contrast to conventional platforms in which the set of users is simply a sample that is used as an estimate to infer what level of benefit the entity likely would have received if all users in its targeted population had received the promotion. That is, the systems and methods definitively maintain access to the exact amount that a target population spends and therefore do not need to rely on an estimate.

Further, the systems and methods may be configured to assign some users into a partner-level control group and maintain the users within this control group for a configurable period. Thus, the systems and methods may specify that these users will not receive a digital promotion(s) from a given partner entity. Because the systems and methods may perform the selection of the control group before promotional activities begin, the systems and methods may run pre-test checks to ensure that this control group is statistically similar to a target population of users that will later receive a set of partner promotions, thus eliminating selection bias in the results.

Additionally, the systems and methods may be configured to track and distinguish the subsequent purchasing behaviors of the users from both conditions so that an accurate comparison can be made between the treatment group and the control group on the desired outcome measures. The systems and methods may accomplish this by providing reward points to each user for every product purchase activity (e.g., a receipt scanned via an app), regardless of whether the product is from a partner entity or not. The systems and methods support an application that is used by both users of the treatment group and users of the control group, where the application is channel via which a given digital promotion is availed and via which product/service purchase data is communicated.

Thus, the embodiments may both assign experimental conditions and collect outcome measures (e.g., partner sales) at the individual user level and, as such, the embodiments ensure accuracy in matching the cause (e.g., partner promotion exposure) to a corresponding effect (e.g., partner KPIs) to provide a more precise measurement of the causal effect. This represents an improvement over conventional technologies related to measuring impact of promotional activities on KPIs, as these conventional technologies attempt to measure the impact of promotional effects by attempting to link store-level outcome data back to experimental conditions that were assigned at the individual level (i.e., a task that cannot be performed with 100% accuracy because the store level data does not distinguish the sales of one individual versus another).

Further still, the systems and methods may account for the dynamic nature of a changing user base by retroactively imposing a cohort methodology on users whereby the systems and methods may identify a group of users who join during a common time period, and group the users together in a cohort that is separate from other cohorts. This ensures that control users for each cohort are appropriate counterfactuals for the treatment users.

Moreover, the systems and methods may incorporate a variable partner client billing structure. In particular, even though the systems and methods may be configured to observe partner KPIs in both the treatment population and the control group, it may be configured that partners only pay a fee when a user from the treatment population makes a purchase (i.e., the partners only pay for the promotional activity when it actually works). As such, the extra benefits received from the treatment population compared to the control group aligns with the extra cost the partner may pay for conducting the promotion on the treatment population and not the control group.

The systems and methods offer numerous commercial competitive advantages for partner entities. For instance, the systems and methods offer precision with which partner entities can interpret the performances of their marketing campaigns. Additionally, by employing certain RCT features, the systems and methods eliminate selection bias which allows for unbiased comparisons between experimental conditions, which ensures that the only differences observed between the treatment and control groups is the difference in exposure to partner entity promotions and random sampling error. Statistical tests, in turn, enable the systems and methods to ascertain the probability that an observed difference is solely due to random sampling error.

Additionally, treatment and control groups are based on observed behavior instead of self-reported demographics, which further highlights the improvements on existing technologies that the systems and methods offer. Certain of the collected data is stock keeping unit (SKU)-level data which enables the systems and methods to provide much deeper insights into the buying habits of consumers across many different channels. Further, the systems and methods remove the uncertainty surrounding seasonality and external market factors because the systems and methods are configured to measure the purchasing behavior of both control and treatment groups during the promotional period in a closed-loop environment. Moreover, because product/service purchases may be verified through user-supplied data (e.g., digital images of receipts), the systems and methods can tie performance metrics back to individual users with a great amount of accuracy.

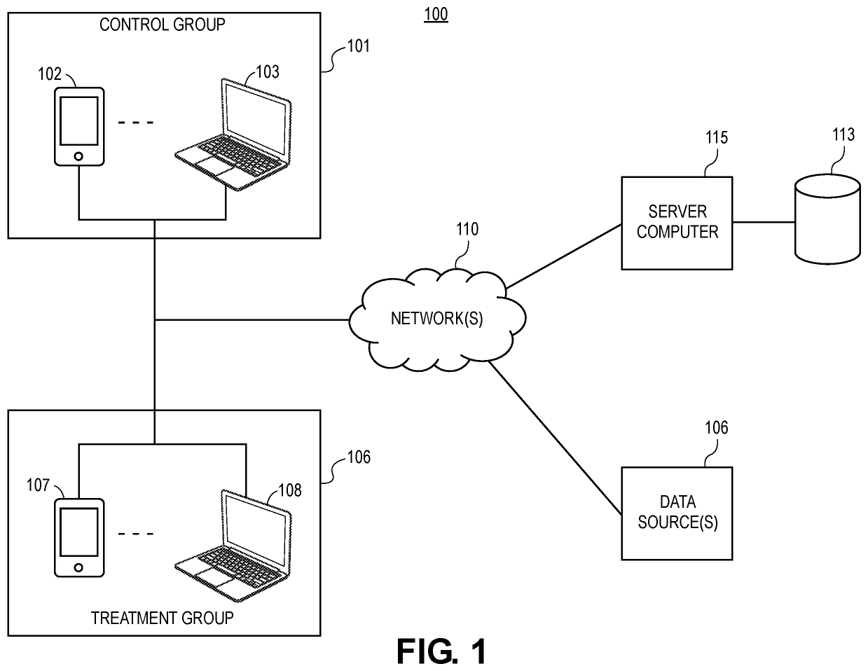

FIG. 1 illustrates an overview of a system 100 of components configured to facilitate the systems and methods. It should be appreciated that the system 100 is merely an example and that alternative or additional components are envisioned.

As illustrated in FIG. 1, the system 100 may include a plurality of electronic devices that are segmented into a control group 101 and a treatment group 106. In particular, the control group 101 may include a set of electronic devices 102, 103 and the treatment group 106 may include a set of electronic devices 107, 108. Each of the electronic devices 102, 103, 107, 108 may be used or operated by user, such as any individual or person who may be interested in purchasing items, products, and/or services that may be offered for sale or for purchase by an entity. In an embodiment, the entity may be a corporation, company, partnership, retailer, service business, wholesaler operating on behalf of another entity (e.g., a white label wholesaler), or the like, where the entity may offer an ecommerce platform (e.g., a website accessible by or an application executable by the electronic devices 102, 103, 107, 108) and/or a set of brick-and-mortal retail stores. Each of the electronic devices 102, 103, 107, 108 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like.

The electronic devices 102, 103, 107, 108 may communicate with a server computer 115 via one or more networks 110. The server computer 115 may be associated with an entity (e.g., a corporation, company, partnership, or the like) that may manage and facilitate digital rewards and/or promotions/offers for users, such as the set of users associated with the electronic devices 102, 103, 107, 108. In particular, the server computer 115 may include or support a web server configured to host a website which with the electronic devices 102, 103, 107, 108 may interface, such as to communicate indications of the purchase of any products, goods, and/or services, to receive reviews for the products, goods, and/or services, to present a set of digital promotions/offers related to a set of products, and/or to present various visual content. For instance, a set of users of the set of electronic devices 102, 103, 107, 108 may capture one or more digital images (e.g., using an image sensor of the electronic devices 102, 103, 107, 108) of a receipt(s) indicating a set of products/services that were purchased by the users, either within a brick and mortar store or via an ecommerce platform, or another purchasing channel.

Further, the server computer 115 may support a software application executable by the set of electronic devices 102, 103, 107, 108 (i.e., the set of electronic devices 102, 103, 107, 108 may interface with the server computer 115 in executing the software application), where the user may use the software application to review certain digital promotions associated with certain products/services, communicate information indicative of product/service purchases, and where the software application may notify of product/service rewards and display various content. Additionally, the users of the electronic devices 102, 103, 107, 108 may have an account with a service or application offered by the server computer 115. In embodiments, the network(s) 110 may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others).

The server computer 115 may be configured to interface with or support a memory or storage 113 capable of storing various data, such as in one or more databases or other forms of storage. According to embodiments, the storage 113 may store data or information associated with any products or services that are offered for sale or purchase by an entity, including any purchase history(ies) of a set of users, any reviews of products/services provided by users, and/or other data. Further, the storage 113 may store any digital promotions that may be available in association with the purchase of a specified set of products/services, as well as the rewards that are associated with the digital promotions. According to embodiments, the digital promotions and any associated data stored by the storage 113 may be updated, added to, and/or deleted from, such as by an administrator associated with the server computer 115, and/or as requested by one or more data source(s) 106.

The server computer 115 may communicate with the one or more data source(s) 106 via the network(s) 110. In embodiments, the data source(s) 106 may be associated with any company involved in the development, manufacture, distribution, providing, and/or sales of one or more products and/or services. For example, the company may be a CPG company, private label brand company, direct-to-consumer (DTC) company, e-commerce marketplace provider, local/specialty retailer, service provider, and/or the like. Generally, each company associated with the data source(s) 106 may be interested in marketing campaigns for its products and/or services, such as to raise brand awareness, differentiate its products/services from competitors, generate sales, build customer loyalty, and introduce new products/services, among other reasons.

According to embodiments, each company associated with the data source(s) 106 may look to offer a set of digital promotions or offers to individuals (e.g., the users of the electronic devices 102, 103, 107, 108). As generally understood, a digital promotion may specify a certain digital reward for purchasing the product or service, and may be intended to increase sales, attract new consumers, retain existing consumers, and launch a new product, among other purposes. For example, a digital promotion may specify a reward of 5,000 points for the purchase of a specific product or service. A user (e.g., a user of one of the set of electronic devices 102, 103, 107, 108) may earn a specified amount of points for purchasing the product or service as specified by the digital promotion, which may be added to a point balance for that user. Further, the user redeem a given amount of points for one or more rewards including, for example, a gift card, a free or discounted product(s) and/or service(s), a subscription service, contest or sweepstakes entry, exclusive content, real life or virtual experiences, and/or other rewards. For example, a user may purchase a $25 gift card for an online retailer by redeeming 25,000 points.

According to embodiments, the server computer 115 may determine how to segment the set of electronic devices 102, 103, 107, 108 into either the control group 101 or the treatment group 106. In embodiments, the server computer 115 may determine or access a holdout percentage whereby the amount of electronic devices in the control group 101 corresponds to the holdout percentage. For example, if there are 10,000 electronic devices and the holdout percentage is 10%, the treatment group 106 will have 9,000 electronic devices and the control group 101 will have 1,000 electronic devices.

Additionally, a partner entity (e.g., an entity associated with one of the data source(s) 106) may want to promote a certain product or service via a digital promotion that specifies a reward associated with the purchase of the product/service. Accordingly, the server computer 115 may avail, via the application, the digital promotion for the product/service to the electronic devices 107, 108 of the treatment group 106, and withhold availing (i.e., not avail) the digital promotion for the product/service to the electronic devices 102, 103 of the control group 101. Accordingly, the users of the electronic devices 107, 108 of the treatment group 106 are eligible to redeem the digital promotion for the indicated reward, while the users of the electronic devices 102, 103 of the control group 101 are not eligible to redeem the digital promotion for the indicated reward.

The set of electronic devices 102, 103, 107, 108 may provide, to the server computer 115, data indicating a set of products/services purchased by the set of individuals associated with the set of electronic devices 102, 103, 107, 108. In embodiments, the data source(s) 106 may store data indicating product purchases by individuals associated with the set of electronic devices 102, 103, 107, 108. In this regard, the data source(s) 106 may be associated with an e-mail provider, an ecommerce retailer, or another component or entity, and the server computer 115 may retrieve this data from the data source(s) 106. The server computer 115 may examine this provided data to identify the set of products/services as well as determine a set of rewards associated with the purchase of the set of products/services, where the reward may have associated an amount of points or other metric or reward.

The products/services purchase data may indicate whether the certain product or service as specified in the digital promotion was purchased by any of the users associated with the set of electronic devices 102, 103, 107, 108. If any of the users of the treatment group devices 107, 108 purchased the certain product or service, the server computer 115 may apply, to an account of any purchasing user, the reward (e.g., an amount of points) specified by the digital promotion. Additionally, if any of the users of the control group devices 102, 103 purchased the certain product or service, the server computer 115 may apply, to an account of any purchasing user, another reward (e.g., a default minimum amount of points), or may not apply any reward. Further, the server computer 115 may apply, to corresponding accounts, any additional rewards associated with the purchase of any additional products and/or services. The server computer 115 may communicate an indication of any applied rewards to any of the electronic devices 102, 103, 107, 108 having users that purchased any products and/or services. Moreover, the server computer 115 may calculate certain performance metrics associated with any digital promotions involving the control group 101 and the treatment group 106, and may avail that information to an associated partner entity. Additional aspects of these functionalities are described with respect to the other figures.

Although depicted as a single server computer 115 in FIG. 1, it should be appreciated that the server computer 115 may be in the form of a distributed cluster of computers, servers, machines, cloud-based services, or the like. In this implementation, the entity may utilize the distributed server computer(s) 115 as part of an on-demand cloud computing platform. Accordingly, when the electronic devices 102, 103, 107, 108 interface with the server computer 115, the electronic devices 102, 103, 107, 108 may actually interface with one or more of a number of distributed computers, servers, machines, or the like, to facilitate the described functionalities.

Further, although three (4) electronic devices 102, 103, 107, 108, and one (1) server computer 115 are depicted in FIG. 1, it should be appreciated that greater or fewer amounts are envisioned. For example, there may be multiple server computers, each one associated with a different entity.

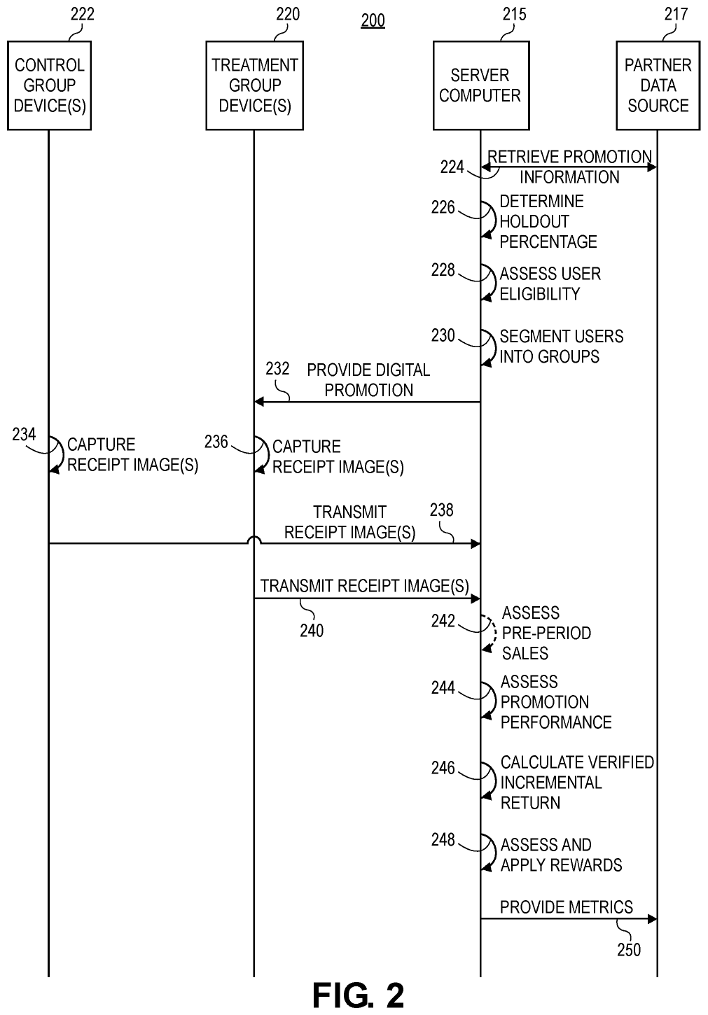

FIG. 2 depicts a signal diagram 200 of various functionalities associated with the described embodiments. The signal diagram 200 may include a set of control group devices 222 (such as the control group devices 102, 103 as discussed with respect to FIG. 1), a set of treatment group devices 220 (such as the treatment group devices 107, 108 as discussed with respect to FIG. 1), a server computer 215 (such as the server computer 115 as discussed with respect to FIG. 1), and a partner data source 217 (such as one of the data source(s) 106 as discussed with respect to FIG. 1) associated with a partner entity.

Although a single server computer and a single partner data source is depicted in and described with respect to FIG. 2, it should be appreciated that multiple server computers and multiple partner data sources are envisioned. In embodiments, the server computer 215 may be associated with an entity that develops and/or operates an application configured to avail digital promotions and provide digital rewards to users, and the devices 222, 220 may be associated with users who use the application, where the devices 222, 220 and the server computer 215 may communicate via a network connection.

The signal diagram 200 may begin at 224 where the server computer 215 retrieves, from the partner data source 217, information related to a promotion(s) that the partner entity associated with the partner data source 217 may decide to launch or implement, or otherwise contemplate launching or implementing. In embodiments, the information may include details related to a promotion(s) or an offer(s) for a specific product(s)/service(s) or group of products/services. Generally, a given promotion may specify a reward (e.g., an amount of points) associated with the purchase of a specific product or service, where the product or service may be developed, manufactured, distributed, and/or offered by the partner entity. For example, the promotion may specify a reward of 3,000 points to the purchase of a four (4) ounce container of face moisturizer.

While it should be appreciated that the server computer 215 may simultaneously and/or sequentially facilitate multiple promotions for multiple products/services, the following description describes functionalities associated with a single promotion for a single product/service. Generally, the server computer 215 may facilitate the promotion by offering the promotion to the treatment group device(s) 220 and foregoing offering the promotion to the control group device(s) 222 (i.e., the control group device(s) 222 may represent the “holdout” device(s)).

The server computer 215 may determine (226) a holdout percentage for the promotion. In other words, the treatment group device(s) 220 and the control group device(s) 222 may initially be included in a plurality of devices, where the holdout percentage may represent a percentage of the plurality of devices that will be segmented as the control group device(s) 222. According to embodiments, the server computer 215 may determine the holdout percentage according to any determination or technique. For instance, the server computer 215 may determine the holdout percentage by performing a cost-benefit analysis which may take into account a likely amount of revenue lost from the treatment group (i.e., exposing fewer users to promotions) versus the amount to measurement precision gained (i.e., how much the margin of error surrounding any control group estimates is diminished) with every 1% decrease (1% increase) in the number of users assigned to the control condition (treatment condition). It should be appreciated that the holdout percentage may be a default amount (e.g., 5%) that is configurable. Further, it should be appreciated that the server computer 215 may determine the holdout percentage in other manners.

Further, for instance, the server computer 215 may randomly assign users to the treatment group or the control group as the users use their electronic devices to install or create an account with the application, such as for long-term program measurement. In particular, the server computer 215 may perform this assignment using a hashing technique in which an identifier representing a partner program together with an identifier for a given user (e.g., a userId) are input as a single string of alphanumeric characters to a hash function (e.g., SHA1). Using the sixty-four (64) most-significant bits of the output of this function, the server computer 215 may modulus the resulting 64-bit unsigned integer by 100,000 (or another number), the result of this operation being a number from 0 to 99,999. According to a determined holdout percentage, the server computer 215 may select a number (i.e., the holdout percentage*100,000) that serves as a threshold for which any user receiving a modulus greater than this should be assigned to the treatment group. In embodiments, users may maintain their assignments to either the treatment or control group for the remainder of a partner entity contract.

In embodiments, the server computer 215 may determine the holdout percentage in instances of a program-level holdout which is designed to measure the success of an overall partnership that applies a randomized controlled trial segmentation to a user base. This segmentation may allow for measurement of the effectiveness of a relationship with an entity associated with the server computer 215, including accounting for loyalty points, offer points, marketing communications, and exposure in a rewards application that be executed by the treatment group device(s) 220 and the control group device(s) 222.

Further, in embodiments, the server computer 215 may measure the success of individual promotions by applying a randomized controlled trial segmentation to a select group of users, such as users that are deemed qualified or eligible, which may allow for the measurement of the effectiveness of an individual offer. Accordingly, in some situations, the server computer 215 may assess (228) user eligibility. In embodiments, the server computer 215 may assess user eligibility based on past purchasing behavior, which may include, for example, level of spend, frequency of purchase, purchase of competitive brands, length of time using the rewards application, and/or other factors. Further, in embodiments, one of the conditions for eligibility in the individual-level holdout of a given user may be if that user is part of the treatment group for the program-level holdout, where if the given user is not part of the treatment group for the program-level holdout (i.e., is part of the control group for the program-level holdout), the user is not eligible for the individual-level holdout. The server computer 215 may still assess user eligibility for the individual-level holdout based on the listed factors for users that are included in the treatment group for the program-level holdout. That is, a given user may be included in the treatment group for the program-level holdout, but the server computer 215 may still determine that the user is not eligible for the individual-level holdout.

For both program-level and individual-level holdouts, the server computer 215 may segment (230) the associated plurality of users into the control group and the treatment group. In the case of a program-level holdout, the server computer 215 may use the holdout percentage determined in (226) to segment the plurality of users. For example, if there are one thousand (1,000) total users and the holdout percentage is 10%, the server computer 215 may segment one hundred (100) users into the control group and nine hundred (900) users into the treatment group. It should be appreciated that the server computer 215 may segment the users randomly or according to another technique.

Further, in the case of an individual-level holdout, the server computer 215 may segment the plurality of users that are deemed or determined as eligible in (228) into the control group and the treatment group, according to a percentage that is determined (e.g., determined in (226)), or is a set or configurable percentage. For example, if there are five hundred (500) total eligible users and the holdout percentage is 10%, the server computer 215 may segment fifty (50) eligible users into the control group and four hundred and fifty (450) eligible users into the treatment group.

According to embodiments, the set of users in the control group respectively have associated the control group device(s) 222, and the set of users in the treatment group respectively have associated the treatment group device(s) 220. In particular, each of the control group device(s) 222 may execute an application (e.g., a rewards application) for which each of the respective set of users in the control group has an account, and each of the treatment group device(s) 220 may execute an application (e.g., the same rewards application) for which each of the respective set of users in the treatment group has an account.

The server computer 215 may provide (232) or otherwise avail a digital promotion to a user of each of the treatment group device(s) 220. Additionally, the server computer 215 may forego availing (or otherwise not avail) the digital promotion to a user of each of the control group device(s) 222. In embodiments, the digital promotion may be a promotion for a product or service that is retrieved from the partner data source 217 in (224), or may be a promotion that is determined by the server computer 215, for example based on a set of parameters that may be specified by the partner entity associated with the partner data source 217. The respective user(s) of the treatment group device(s) 220 may access and review the digital promotion via the application that executes on the treatment group device(s) 220, or via another channel (e.g., an electronic communication such as an email or SMS, a website, and/or similar channels). For example, the application may display or present the digital promotion in response to the user initiating the application.

In embodiments, the digital promotion may be availed to the treatment group device(s) 220 for a period of time such as, for example, a day, a week, a month, or another time period. Accordingly, upon expiration of the period of time, the digital promotion may no longer be availed to the users of the treatment group device(s) 220. It should be appreciated that, during the period of time, a set of additional digital promotions may be availed to the users of the control group device(s) 222 and the treatment group device(s) 220. Further, during the period of time, users of the treatment group device(s) 220 and the control group device(s) 222 may purchase one or more products or services, with or without accounting for any digital promotions (including the digital promotion provided to the treatment group device(s) 220 in (232)) that are availed to the users.

Generally, during the period of time, any of the control group device(s) 222 and the treatment group device(s) 220 may receive an indication(s) of a product(s) or service(s) that may be purchased by any of the respective users of the device(s) 222, 220, such as in response to a given user initiating a feature or functionality of the application executing on device(s) 222, 220. In an embodiment, a user(s) of the control group device(s) 222 may capture (234) one or more digital images (e.g., using an image sensor of the given device) of a receipt(s) indicating a set of products and/or services that was purchased by the user(s), either within a brick and mortar store or via an ecommerce platform, or another purchasing channel, and a user(s) of the treatment group device(s) 220 may capture (236) one or more digital images (e.g., using an image sensor of the given device) of a receipt(s) indicating a set of products and/or services that was purchased by the user(s), either within a brick and mortar store or via an ecommerce platform, or another purchasing channel. The receipt(s) may be a physical printed receipt or may be a digital receipt that may be displayed by the respective device 222, 220 (where the respective device 222, 220 may capture the digital receipt via, for example, a screenshot).

Any of the control group device(s) 222 may transmit (238) the product/service indication(s) (e.g., the receipt image(s)) to the server computer 215, such as via a network connection, and any of the treatment group device(s) 220 may transmit (240) the product/service indication(s) (e.g., the receipt image(s)) to the server computer 215, such as via a network connection. In another embodiment, the server computer 215 may interface with another device, such as a third party server, that stores data identifying a purchase history of a user(s) associated with any of the devices 222, 220. For example, the third party server may be associated with an ecommerce platform or site that offers various products/services for purchase. For further example, the third party server may be an e-mail provider that receives and stores (e.g., in a user inbox) order confirmations indicating a purchase(s) made by a user(s) of the e-mail provider. It should be appreciated that the control group device(s) 222, 220 may transmit the product/service indication(s) during or after the period of time associated with the digital promotion. However, in certain instances, the user(s) of the treatment group device(s) 220 may be eligible for the reward of the digital promotion by actually purchasing the specified product/service during the period of time associated with the digital promotion.

The server computer 215 may identify a set of products/services that was purchased by users of the control group device(s) and/or the treatment group device(s) 220, such as from the product/service indication(s) that were transmitted in (238) and (240), and/or from a third party server(s) that supplies data identifying a set of purchased products/services. The server computer 215 may identify the set of products/services that was purchased from one or more identifiers, such as a barcode, UPC, ISBN, GTIN, EAN, or other identification, where the identifier(s) may be included on an image of a receipt or on a confirmation of a purchase of a product(s)/service(s). In embodiments, the server computer 215 may perform one or more image recognition techniques on any receipt image(s) received from the devices 222, 220, to identify a set of products/services that is identified on the receipt image(s). In this regard, the server computer 215 may have access to the purchase history (i.e., as identified on the receipt image(s) or from a third party server), analyze the purchase history, and identify any product(s)/service(s) included in the purchase history and therefore purchased by the user(s).

The server computer 215 may, in an optional implementation, assess (242) any pre-period sales. In embodiments, the server computer 215 may assess the pre-period sales for individual-level holdouts. Generally, the pre-period sales may reflect any product/service purchases by the users of the devices 222, 220 that occur prior to the time period of the digital promotion (e.g., in the thirteen (13) weeks prior to the time period of the digital promotion, or other time periods), where the server computer 215 may assess or determine the pre-period sales according to any of the techniques as discussed herein.

The server computer 215 may assess (244) a performance of the promotion, which the server computer 215 may facilitate after the time period associated with the promotion ends, or at another point in time. In embodiments, the server computer 215 may calculate the incremental lift which compares the difference in observed behavior between the treatment and control groups versus the respective sizes of the groups. Generally, the incremental lift may be calculated for multiple consumer behaviors, including incremental revenue (i.e., any additional partner revenue beyond the measurement baseline driven attributable to exposure on the platform), incremental buyers (where the buyers may be considered households; i.e., purchasers of products of a partner that are driven by exposure on the platform), incremental trips (i.e., additional purchasing occasions during the time period of the promotion), and incremental units (i.e., additional volume purchased during the time period of the promotion).

The server computer 215 may calculate the incremental lift percentage by the following equation: ((Treatment Promo X/Treatment Group Size)/(Control Promo X/Control Group Size))−1. In situations in which the server computer 215 assesses any pre-period sales for individual-level holdouts, the server computer 215 may calculate the incremental lift percentage by the following equation: ((Treatment Promo X/Treatment Pre-Period X)/(Control Promo X/Control Pre-Period X))−1. In these equations, the variable “X” may be the observed behavior as discussed herein (e.g., sales, buyers, trips, or units).

The server computer 215 may calculate the incremental sales for the digital promotion, which are the sales attributed to the digital promotion (i.e., quantifying the effect of lift on revenue). In embodiments, the incremental sales may be calculated by the following equation: Treatment Promo Sales−(Treatment Promo Sales/(1+incremental lift percentage)).

The server computer 215 may calculate (246) a verified incremental return (VIR) for the digital promotion. Generally, the VIR may be calculated as the incremental sales (i.e., as calculated by Treatment Promo Sales−(Treatment Promo Sales/(1+incremental lift percentage))) divided by the cost of the digital promotion, where the cost is the cost incurred by the partner entity to offer the digital promotion on the platform.

As discussed herein, a digital promotion for a product/service may offer an amount of points as a reward to the treatment users for purchasing the product/service, where the users may redeem earned points for gift cards and other rewards, effectively resulting in the product/service being discounted. In embodiments, the partner entity may subsidize these points with some markup applied to the points, and may thus incur a cost when a treatment user(s) purchases the product/service. Accordingly, the cost may be calculated as (points awarded*partner markup).

Generally, the VIR is an accurate indicator of the incremental revenue that was attributed to the costs incurred by the partner entity to offer the digital promotion on the platform. VIR is a superior measure for a return on investment for a business than the traditionally-relied-upon return on advertising spend (ROAS) metric. This is because usual ROAS calculations compare the total amount of sales brought in during a promotion period relative to the total costs the business incurred for running the promotion (e.g., total promo sales/cost). However, this is problematic because factors other than the promotion are likely responsible for at least some of the sales the entity receives while the promotion runs (e.g., seasonal fluctuations in consumer demand, competitors having their own promotions, etc.). Accordingly, ROAS cannot accurately answer the question, “was it worth it for the entity to run the promotion given the amount it cost the entity to do so?” In contrast, the VIR metric of the described systems and methods can be relied upon to provide an accurate answer as it is able to actually isolate the amount of extra revenue brought in during a promotion period solely due to the promotion itself. This, in turn, provides the type of information needed to answer the question above (i.e., the revenue benefit the entity received by running the promotion versus the cost incurred by the entity for the promotion).

According to embodiments, the server computer 215 may alternatively or additionally perform quarterly (or other time periods) analyses using a cohort methodology, whereby the server computer 215 accounts for any users that joined the promotion during the same fiscal quarter and groups them together in a cohort that is separate from other cohorts, such as to ensure that the control users for each cohort are appropriate counterfactuals for the treatment users.

The server computer 215 may perform incremental revenue estimates for each cohort based on the average metrics yielded by the within-cohort control group (e.g., average control group sales). In particular, the server computer 215 may calculate a margin of error surrounding a control group estimate with 95% confidence (i.e., critical t-value for 95% confidence*(control group standard deviation/(square root of control group sample size))) and using that to find the 95% confidence interval for the control group estimate (i.e., mean control group sales +/−a margin of error).

Accordingly, based on the central limit theorem, there is a 95% certainty that if the average (mean) sales from the control group sample were extrapolated to a larger population, the average sales for that larger control group would be somewhere between the upper and lower bounds of this confidence interval (CI). For example, if the mean sales for the control group sample is equal to $4.25 and the margin of error for 95% confidence associated with this estimate is $0.25, then statistically there is a 95% probability that the mean sales for a larger control group population would be between $4.25+/−$0.25 (i.e., between $4.50 (the upper limit for the 95% confidence interval) and $4.00 (the lower limit for the 95% confidence interval)).

With the range of values that the average sales of a larger control group would be determined with 95% certainty, it may be determined what the total sales of the control group would have been if the control group had the same number of users as that of the treatment group. As similarly described herein, these total sales values may be determined in terms of a range. In particular, it may be determined what the total control group sales would have been if: (i) the mean value of the control group sample if the control group had the same number of users as that of the treatment group (i.e., average sales for control group sample*the number of users in the treatment group), (ii) the upper limit of the 95% confidence interval if the control group had the same number of users as that of the treatment group (i.e., average sales plus the margin of error for the control group sample*the number of users in the treatment group), and (iii) the lower limit of the 95% confidence interval if the control group had the same number of users as that of the treatment group (i.e., averages sales minus the margin of error for the control group sample*the number of users in the treatment group). From this, it may be known with 95% confidence that the average sales for a control group that is the same size as the treatment group would have been somewhere within this range of values. In embodiments, these three values may serve as estimates of total control group sales for a population that had the same size as the treatment group.

In embodiments, the determined total control group sales values may be subtracted from the total sales of the treatment group to yield a range of differences between the amount of sales attributed to the treatment group for the partner entity versus the amount of sales that a control group having the same size of the treatment group size would have generated. This range of differences may be referred to as an “incremental revenue” as it represents a range of the extra amount of revenue that the partner entity likely received by choosing to run its promotion on the platform, as compared to not running its promotion on the platform.

In embodiments, three separate incremental revenue values may be determined: (i) what the incremental revenue would have been if the average sales of a larger control group was the upper limit of the 95% confidence interval, (ii) what the incremental revenue would have been if the average sales of a larger control group was the same as the average of the control group sample, and (iii) what the incremental revenue would have been if the average sales of a larger control group was the lower limit of the 95% confidence interval.

In embodiments, incremental revenue values may be summed across each cohort to create a measure that is indicative of the total amount of incremental revenue the partner entity received from the platform. Accordingly, this yields three separate measures that represent the range of what the total incremental revenue would be with 95% certainty.

Additionally, each of the total incremental revenue values may be divided by the total costs the partner entity incurred to promote its offerings to the treatment group, which is also referred to herein as the verified incremental return (VIR) of the partner. As similarly discussed herein, the VIR may be presented in the form of three values: (i) VIR when using a control group mean, (ii) VIR when using an upper 95% limit for the control group, and (iii) VIR when using lower 95% limit for the control group. In other words, the VIR plus and/or minus the margin of error from control group estimates.

As illustrated in FIG. 2, the server computer 215 may assess and apply (248) rewards or points to relevant accounts to users of the control group device(s) 222 and/or the treatment group device(s) 220. In particular, the server computer 215 may identify any products/services that were purchased by the users from the receipt image(s) that were transferred in (238) and (240), and determine a reward (e.g., an amount of points or other reward metric) associated with each of the products/services. Further, the server computer 215 may apply, to account(s) of the user(s) who purchased the products/services, the reward(s) associated with the products/services.

The server computer 215 may also provide (250) a set of metrics associated with the digital promotion to the partner data source 217, such as to avail the set of metrics to the partner entity. According to embodiments, the set of metrics may include any calculated or determined calculations or metrics, as discussed herein (e.g., incremental sales, VIR, etc.). Accordingly, the partner entity may review the set of metrics to assess KPIs, assess the digital promotion, and/or strategize on subsequent digital promotions, among other uses.

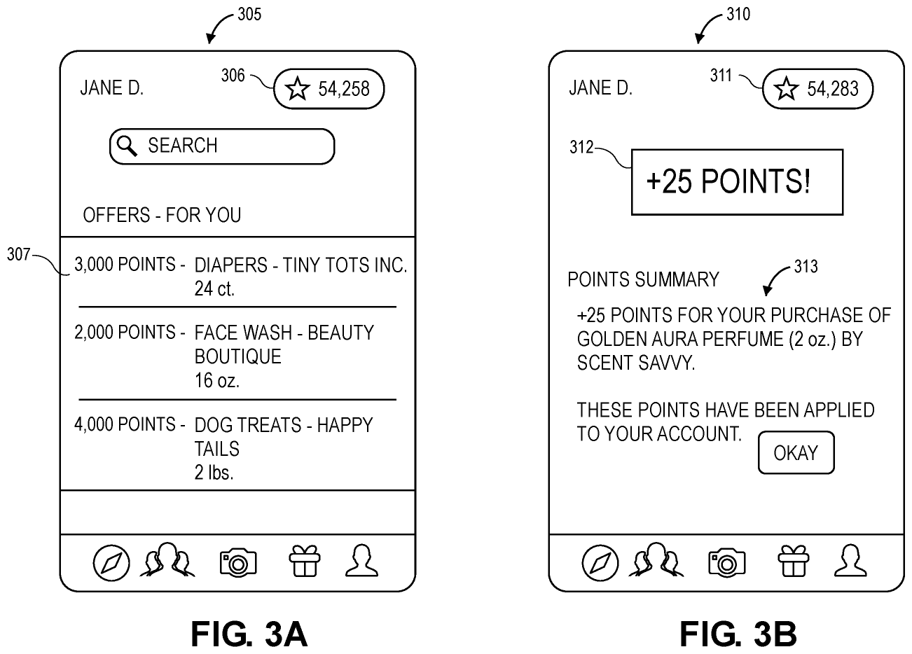

FIGS. 3A, 3B, 4A, 4B, 5A, and 5B illustrate example interfaces that may be displayed on a user interface of an electronic device. In embodiments, the interfaces may be associated with an application executable by, or a website accessed by, the electronic device (as generally used herein, an “application”). Further, the interfaces may be specific to a user of the electronic device, where the user may access the interfaces by logging into an account or via another type of access. It should be appreciated that the content of the interfaces is exemplary, and that alternative or additional content is envisioned.

FIGS. 3A and 3B illustrate interfaces that may be displayed on an electronic device of a user belonging to a control group, such as one of the control group device(s) 222 as discussed with respect to FIG. 2. In particular, FIG. 3A illustrates an interface 305 that may be associated with a home screen (or another interface) of the application, where the control user of the application is indicated as Jane D. The interface 305 may indicate (306) an existing points balance for the control user, and may also include a section that highlights a set of promotions or offers available to the control user. For example, one of the promotions is a promotion 307 indicating that the control user will be awarded 3,000 points by purchasing a twenty-four count package of diapers from Tiny Tots Inc. The control user may review the set of promotions which may influence which products/services the control user purchases.

The control user may purchase various product(s) and/or service(s), which may be the same as or different from those indicated as having a promotion. Further, the control user may use the electronic device to scan and upload receipt(s) that indicate a purchase of a set of products and/or services. FIG. 3B illustrates an interface 310 that indicates a purchase of a product by the control user. In particular, the interface 310 indicates (313) that the control user purchased a two (2) oz. bottle of Golden Aura perfume from the brand Scent Savvy.

In this scenario, the control user was not offered a promotion for the Golden Aura perfume. Nevertheless, the control user still purchased the Golden Aura perfume and, as a result of the purchase, was awarded twenty-five (25) points, as indicated by 312 in FIG. 3B. It should be appreciated that different amounts of points may be awarded for the purchase of a product or service that does not have a promotion, including zero (0) points. A points balance 311 for the control user may be updated as a result of the points reward (i.e., the points balance 306 indicated in FIG. 3A is increased by twenty-five (25) points).

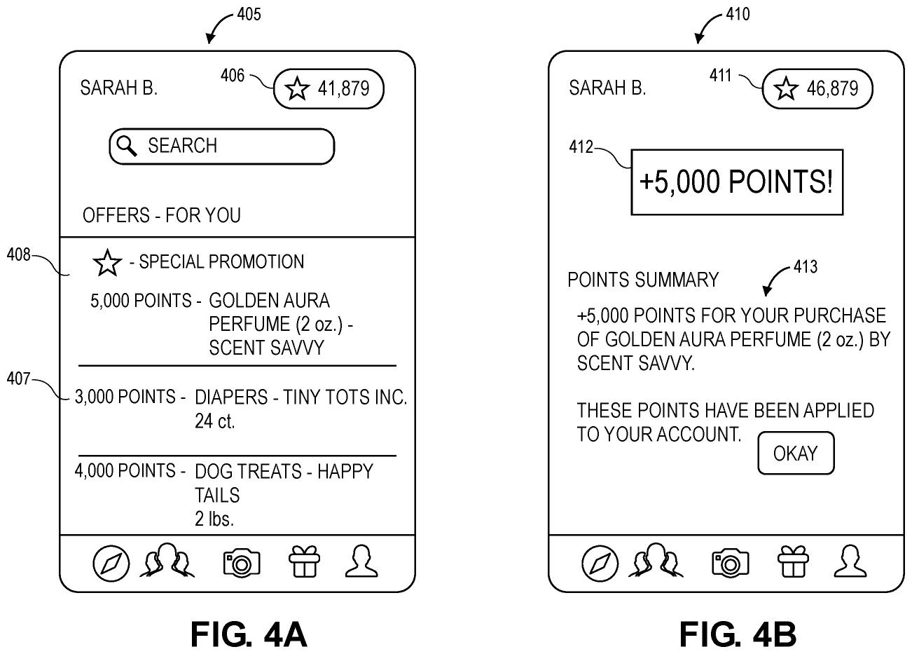

FIGS. 4A and 4B illustrate interfaces that may be displayed on an electronic device of a user belonging to a treatment group, such as one of the treatment group device(s) 220 as discussed with respect to FIG. 2. In particular, FIG. 4A illustrates an interface 405 that may be associated with a home screen (or another interface) of the application, where the treatment user of the application is indicated as Sarah B. The interface 405 may indicate (406) an existing points balance for the treatment user, and may also include a section that highlights a set of promotions or offers available to the treatment user. For example, one of the promotions is a promotion 407 indicating that the treatment user will be awarded 3,000 points by purchasing a twenty-four count package of diapers from Tiny Tots Inc. Additionally, another of the promotions is a special promotion 408 indicating that the treatment user will be awarded 5,000 points by purchasing a two (2) oz. bottle of Golden Aura perfume from the brand Scent Savvy (i.e., the same perfume that was purchased by the control user). The treatment user may review the set of promotions which may influence which products/services the treatment user purchases.

The treatment user may purchase various product(s) and/or service(s), which may be the same as or different from those indicated as having a promotion. Further, the treatment user may use the electronic device to scan and upload receipt(s) that indicate a purchase of a set of products and/or services. FIG. 4B illustrates an interface 410 that indicates a purchase of a product by the treatment user. In particular, the interface 410 indicates (413) that the treatment user purchased the two (2) oz. bottle of Golden Aura perfume from the brand Scent Savvy.

In this scenario, the treatment user was offered the promotion (408) for the Golden Aura perfume. Therefore, the application awarded the treatment user 5,000 points, as indicated by 412 in FIG. 4B. A points balance 411 for the treatment user may be updated as a result of the points reward (i.e., the points balance 406 indicated in FIG. 4A is increased by 5,000 points).

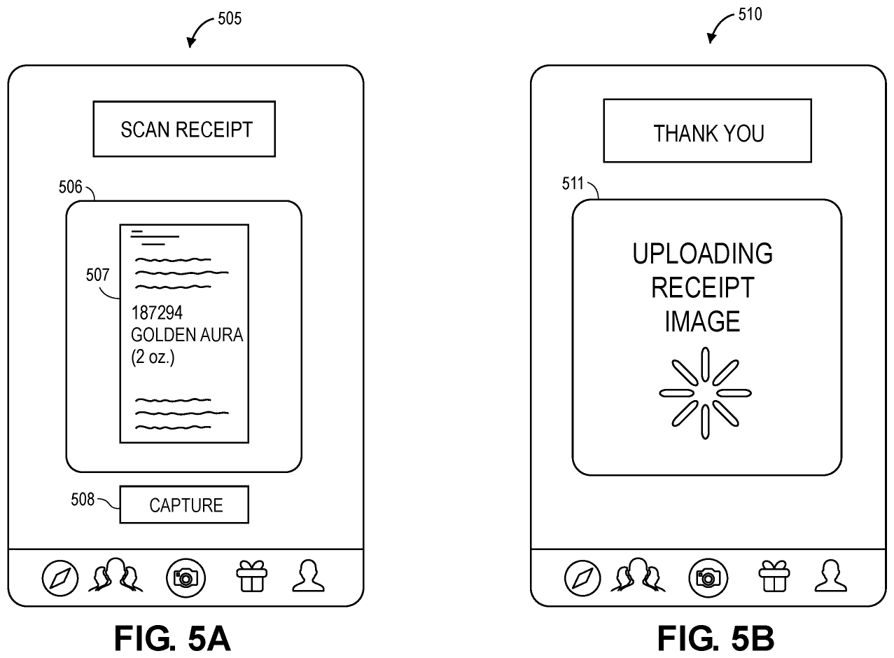

FIGS. 5A and 5B illustrate example interfaces that may be displayed on an electronic device of a user belonging to either a control group or a treatment group. If the example interfaces of FIGS. 5A and 5B are associated with a control group device, the example interfaces may be displayed between the functionalities and content depicted in FIGS. 3A and 3B; and if the example interfaces of FIGS. 5A and 5B are associated with a treatment group device, the example interfaces may be displayed between the functionalities and content depicted in FIGS. 4A and 4B.

FIG. 5A illustrates an interface 505 that enables a user to upload an image of a receipt that indicates a purchase of a set of products/services. In particular, the interface 505 includes a “live view” window 506 that indicates the image data that an image sensor of the electronic device may capture or generate. The user may position a receipt 507 within the window 506, and may select to cause the electronic device to capture a digital image of the receipt 507 by selecting a capture selection 508. As illustrated in FIG. 5A, the receipt 507 indicates that the Golden Aura perfume was purchased.

In response to the user selecting the capture selection 508 or in response to another trigger (e.g., the user selecting to upload the digital image), the electronic device may upload the captured digital image to a server. FIG. 5B illustrates an interface 510 depicting an indication 511 that the receipt image is being uploaded. According to embodiments, the server may analyze the receipt image, identify the purchased product (i.e., the Golden Aura perfume), determine a reward associated with the purchased product, and transmit an indication of the reward to the electronic device. If the example interfaces of FIGS. 5A and 5B are associated with a control group device, the electronic device may display the interface 310 as depicted in FIG. 3B; and if the example interfaces of FIGS. 5A and 5B are associated with a treatment group device, the electronic device may display the interface 410 as depicted in FIG. 4B.

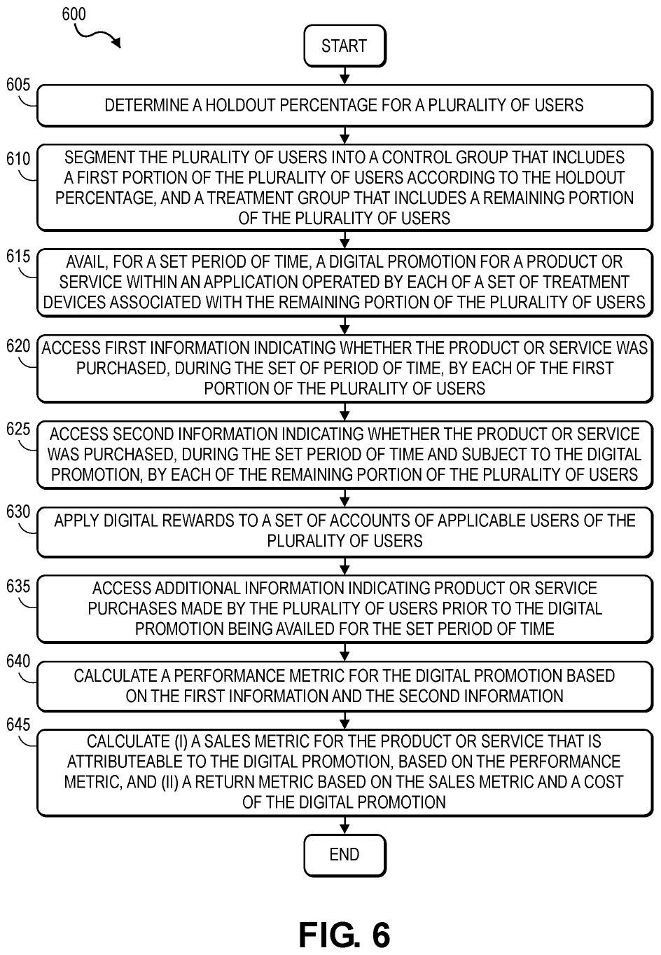

FIG. 6 is a block diagram of an example method 600 of assessing performance of a digital promotion for a partner entity and associated with a product or service. The method 600 may be facilitated by a server computer (such as the server computer 215 as discussed with respect to FIG. 2) or other type of electronic device.

The method 600 begins at block 605 in which the server computer determines a holdout percentage for a plurality of users, where the holdout percentage may be a default amount or may be determined based on one or more parameters. The server computer may segment (block 610) the plurality of users into a control group that includes a first portion of the plurality of users according to the holdout percentage, and a treatment group that includes a remaining portion of the plurality of users. In embodiments, a set of control devices is respectively associated with the first portion of the plurality of users and a set of treatment devices is respectively associated with the remaining portion of the plurality of users.

The server computer may avail (block 615), for a set period of time, a digital promotion for a product or service within an application operated by each of the set of treatment devices associated with the remaining portion of the plurality of users. In embodiments, the digital promotion may be reviewable, via the application, by each of the remaining portion of the plurality of users associated with the set of treatment devices, and the application may indicate a reward associated with the digital promotion (e.g., an amount of points for purchasing the product or service).

The server computer may access (block 620) first information indicating whether the product or service was purchased, during the set period of time, by each of the first portion of the plurality of users respectively associated with the set of control devices. Additionally, the server computer may access (block 625) second information indicating whether the product or service was purchased, during the set period of time and subject to the digital promotion, by each of the remaining portion of the plurality of users respectively associated with the set of treatment devices. In receiving the first and second information, the server computer may receive (i) a first set of digital image data from at least a portion of the set of control devices, and (ii) a second set of digital image data from at least a portion of the set of treatment devices, and analyze (i) the first set of digital image data to determine the first information, and (ii) the second set of digital image data to determine the second information.

The server computer may apply (block 630) digital rewards to a set of accounts of applicable users of the plurality of users. In embodiments, the server computer may apply, to an account of each of the first portion of the plurality of users who purchased the product or service, a first digital reward having a first value, and apply, to an account of each of the remaining portion of the plurality of users who purchased the product or service subject to the digital promotion, a second digital reward having a second value greater than the first value. Further, in embodiments, the second value of the second digital reward may have an associated cost to the partner entity.

The server computer may access (block 635) additional information indicating product or service purchases made by the plurality of users prior to the digital promotion being availed for the set period of time, such as if the digital promotion is being held as part of an offer-level holdout.

The server computer may calculate (block 640) a performance metric for the digital promotion based on the first information and the second information. In embodiments, the server computer may calculate the performance metric for the digital promotion based on a first amount of sales of the product or service by the first portion of the plurality of users, an amount of the first portion of the plurality of users, a second amount of sales of the product or service by the remaining portion of the plurality of users, and an amount of the remaining portion of the plurality of users. In embodiments in which the server computer accesses additional information indicating product or service purchases made by the plurality of users prior to the digital promotion being availed for the set period of time, the server computer may calculate the performance metric based on the first information, the second information, and the additional information.

The server computer may calculate (block 645) (i) a sales metric for the product or service that is attributable to the digital promotion, based on the performance metric, and (ii) a return metric based on the sales metric and a cost of the digital promotion. In embodiments, the cost of the digital promotion may be at least partially based on the associated cost to the partner entity of the second value of the second digital reward.

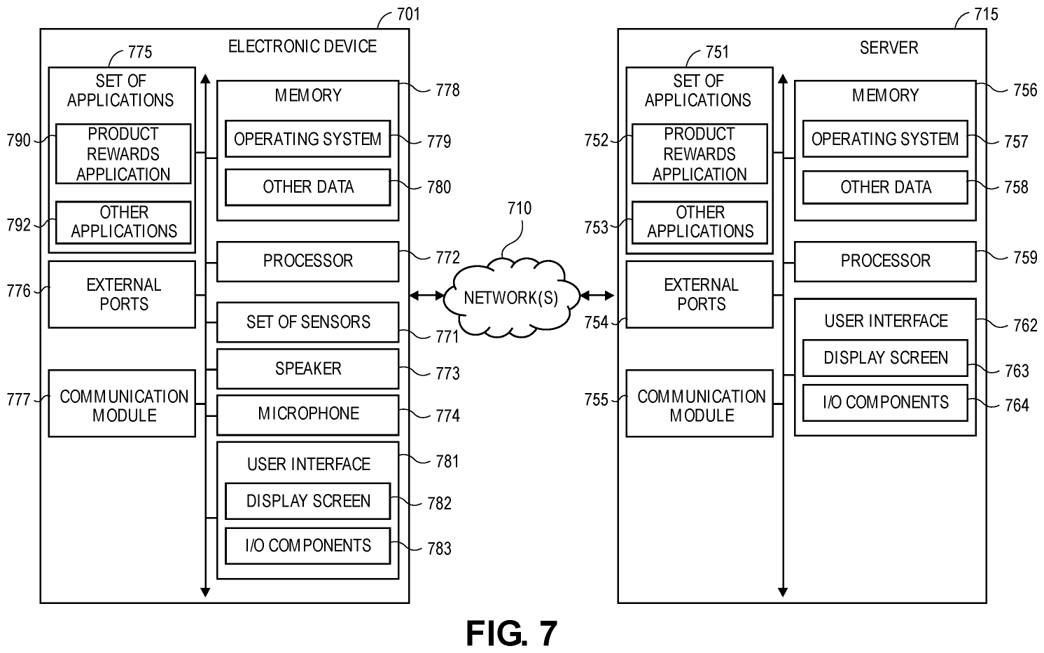

FIG. 7 illustrates a hardware diagram of an example electronic device 701 (e.g., one of the electronic devices 102, 103, 107, 108 as described with respect to FIG. 1) and an example server 715 (e.g., one of the server computers 115, 215 as described with respect to FIGS. 1 and 2), in which the functionalities as discussed herein may be implemented. It should be appreciated that the components of the electronic device 701 and the server 715 are merely exemplary, and that additional or alternative components and arrangements thereof are envisioned.

The electronic device 701 may include a processor 772 as well as a memory 778. The memory 778 may store an operating system 779 capable of facilitating the functionalities as discussed herein as well as a set of applications 775 (i.e., machine readable instructions). For example, one of the set of applications 775 may be a product rewards application 790, such as to present digital promotions, communicate indications of purchased products or services, manage rewards accounts, and/or facilitate other functionalities. It should be appreciated that one or more other applications 792 are envisioned.

The processor 772 may interface with the memory 778 to execute the operating system 779 and the set of applications 775. According to some embodiments, the memory 778 may also store other data 780, such as digital promotion data, account information, and/or other data. The memory 778 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 701 may further include a communication module 777 configured to communicate data via one or more networks 710. According to some embodiments, the communication module 777 may include one or more transceivers (e.g., WAN, WWAN, WLAN, and/or WPAN transceivers) functioning in accordance with IEEE standards, 3GPP standards, or other standards, and configured to receive and transmit data via one or more external ports 776.

The electronic device 701 may include a set of sensors 771 such as, for example, a location module (e.g., a GPS chip), an image sensor, an accelerometer, a clock, a gyroscope (i.e., an angular rate sensor), a compass, a yaw rate sensor, a tilt sensor, telematics sensors, and/or other sensors. The electronic device 701 may further include a user interface 781 configured to present information to a user and/or receive inputs from the user. As shown in FIG. 7, the user interface 781 may include a display screen 782 and I/O components 783 (e.g., ports, capacitive or resistive touch sensitive input panels, keys, buttons, lights, LEDs, and/or built in or external keyboard). Additionally, the electronic device 701 may include a speaker 773 configured to output audio data and a microphone 774 configured to detect audio.

In some embodiments, the electronic device 701 may perform the functionalities as discussed herein as part of a “cloud” network or may otherwise communicate with other hardware or software components within the cloud to send, retrieve, or otherwise analyze data.

As illustrated in FIG. 7, the electronic device 701 may communicate and interface with the server 715 via the network(s) 710. The server 715 may include a processor 759 as well as a memory 756. The memory 756 may store an operating system 757 capable of facilitating the functionalities as discussed herein as well as a set of applications 751 (i.e., machine readable instructions). For example, one of the set of applications 751 may be a product rewards application 752, such as to analyze indications of purchased products or services, manage rewards accounts, and/or facilitate other functionalities. It should be appreciated that one or more other applications 753 are envisioned, such as an application configured to assess performance metrics associated with digital promotions.

The processor 759 may interface with the memory 756 to execute the operating system 757 and the set of applications 751. According to some embodiments, the memory 756 may also store other data 758, such as product or service data, digital promotion data, rewards information, account data, and/or other data. The memory 756 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 715 may further include a communication module 755 configured to communicate data via the one or more networks 710. According to some embodiments, the communication module 755 may include one or more transceivers (e.g., WAN, WWAN, WLAN, and/or WPAN transceivers) functioning in accordance with IEEE standards, 3GPP standards, or other standards, and configured to receive and transmit data via one or more external ports 754.

The server 715 may further include a user interface 762 configured to present information to a user and/or receive inputs from the user. As shown in FIG. 7, the user interface 762 may include a display screen 763 and I/O components 764 (e.g., ports, capacitive or resistive touch sensitive input panels, keys, buttons, lights, LEDs, external or built in keyboard). According to some embodiments, the user may access the server 715 via the user interface 762 to review information, make selections, and/or perform other functions.

In some embodiments, the server 715 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processors 772, 759 (e.g., working in connection with the respective operating systems 779, 757) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

1. A computer-implemented method of availing digital promotions, the computer-implemented method comprising:
retrieving, by at least one computer processor of a server computer from a partner data source, promotion information specifying a reward associated with purchase of a product or service;
maintaining, by the at least one computer processor, a listing of a plurality of users of an application facilitated by the server computer, wherein each user of the plurality of users has an account with the application;
segmenting, by the at least one computer processor, the plurality of users into a control group that includes a first portion of the plurality of users and a treatment group that includes a remaining portion of the plurality of users, wherein a set of control devices is respectively associated with the first portion of the plurality of users and a set of treatment devices is respectively associated with the remaining portion of the plurality of users, and wherein the application facilitated by the server computer is operated by each of the set of control devices and each of the set of treatment devices;
providing, by the at least one computer processor to each of the set of treatment devices, a digital promotion corresponding to the reward associated with the purchase of the product or service;
causing a user interface associated with the application operated by each of the set of treatment devices to (i) present the digital promotion in response to initiation of the application at each of the set of treatment devices, and (ii) avail, during a set period of time, the digital promotion, wherein the user interface indicates the reward associated with the purchase of the product or service, and wherein upon expiration of the set period of time, the user interface no longer avails the digital promotion;
causing the user interface associated with the application operated by each of the set of control devices to avail, during the set period of time, a set of additional digital promotions that does not include the digital promotion;
receiving, by the at least one computer processor from at least a portion of the set of control devices, a first set of digital images depicting a first set of receipts and captured by an image sensor of each of at least the portion of the set of control devices, wherein the first set of digital images was captured in response to an initiation of a feature of the application operated by each of at least the portion of the set of control devices;
receiving, by the at least one computer processor from at least a portion of the set of treatment devices, a second set of digital images depicting a second set of receipts and captured by an image sensor of each of at least the portion of the set of treatment devices, wherein the second set of digital images was captured in response to an initiation of the feature of the application operated by each of at least the portion of the set of treatment devices;
analyzing, by the at least one computer processor, the first set of digital images, including:
using an image recognition technique to identify at least one identifier included in each digital image of the first set of digital images, and
determining, from the at least one identifier included in each digital image of the first set of digital images, that the product or service was purchased, during the set period of time, by each of a subset of the first portion of the plurality of users respectively associated with the set of control devices, resulting in a first amount of sales of the product or service,
analyzing, by the at least one processor, the second set of digital images, including:
using the image recognition technique to identify at least one identifier included in each digital image of the second set of digital images, and
determining, from the at least one identifier included in each digital image of the second set of digital images, that the product or service was purchased, during the set period of time and subject to the digital promotion, by each of a subset of the remaining portion of the plurality of users respectively associated with the set of treatment devices, resulting in a second amount of sales of the product or service,
applying, to the account of each of the subset of the remaining portion of the plurality of users, the reward for purchasing the product or service;
applying, to the account of each of the subset of the first portion of the plurality of users, an additional reward for purchasing the product or service, wherein the additional reward is different from the reward;
determining, by the at least one computer processor using the image recognition technique, (i) a third amount of sales of the product or service, among the first portion of the plurality of users in the control group, that occurred in a defined time period prior to a start of the set period of time, and (ii) a fourth amount of sales of the product or service, among the remaining portion of the plurality of users in the treatment group, that occurred in the defined time period prior to the start of the set period of time;
calculating, by the at least one computer processor, an incremental lift percentage for the digital promotion, wherein the incremental lift percentage is the quantity one subtracted from the quotient of (i) the second amount of sales divided by the fourth amount of sales, divided by (ii) the first amount of sales divided by the third amount of sales;
calculating, by the at least one computer processor, an amount of incremental sales for the digital promotion, wherein the amount of incremental sales is the second amount of sales minus the quotient of (i) the second amount of sales divided by (ii) the quantity one added to the incremental lift percentage;
calculating, by the at least one computer processor, a verified incremental return for the digital promotion, wherein the verified incremental return is the quotient of the amount of incremental sales divided by a cost of the digital promotion; and
providing, by the at least one computer processor to a partner data source, a set of metrics comprising at least one of: the amount of incremental sales or the verified incremental return, to enable the partner data source to review the set of metrics to at least one of: assess a set of key performance indicators (KPIs), assess the digital promotion, or strategize on a subsequent digital promotion.

2. (canceled)

3. The computer-implemented method of claim 1, wherein segmenting the plurality of users comprises:
determining, by the at least one computer processor, a holdout percentage of the plurality of users; and
segmenting, by the at least one computer processor, the plurality of users into the control group that includes the first portion of the plurality of users according to the holdout percentage and the treatment group that includes the remaining portion of the plurality of users.

4-8. (canceled)

9. A system for availing digital promotions, comprising:
a memory storing a set of computer-readable instructions and a listing of a plurality of users of an application, wherein each user of the plurality of users has an account with the application;
one or more processors interfaced with the memory, and configured to execute the set of computer-readable instructions to cause the one or more processors to:
retrieve, from a partner data source, promotion information specifying a reward associated with purchase of a product or service,
segment the plurality of users into a control group that includes a first portion of the plurality of users and a treatment group that includes a remaining portion of the plurality of users, wherein a set of control devices is respectively associated with the first portion of the plurality of users and a set of treatment devices is respectively associated with the remaining portion of the plurality of users, and wherein the application facilitated by the server computer is operated by each of the set of control devices and each of the set of treatment devices,
provide, to each of the set of treatment devices, a digital promotion corresponding to the reward associated with the purchase of the product or service;
cause a user interface associated with the application operated by each of the set of treatment devices to (i) present the digital promotion in response to initiation of the application at each of the set of treatment devices, and (ii) avail, during a set period of time, the digital promotion, wherein the user interface indicates the reward associated with the purchase of the product or service, and wherein upon expiration of the set period of time, the user interface no longer avails the digital promotion,
cause the user interface associated with the application operated by each of the set of control devices to avail, during the set period of time, a set of additional digital promotions that does not include the digital promotion,
receive, from at least a portion of the set of control devices, a first set of digital images depicting a first set of receipts and captured by an image sensor of each of at least the portion of the set of control devices, wherein the first set of digital images was captured in response to an initiation of a feature of the application operated by each of at least the portion of the set of control devices,
receive, from at least a portion of the set of treatment devices, a second set of digital images depicting a second set of receipts and captured by an image sensor of each of at least the portion of the set of treatment devices, wherein the second set of digital images was captured in response to an initiation of the feature of the application operated by each of at least the portion of the set of treatment devices,
analyze the first set of digital images, including:
use an image recognition technique to identify at least one identifier included in each digital image of the first set of digital images, and
determine, from the at least one identifier included in each digital image of the first set of digital images, that the product or service was purchased, during the set period of time, by each of a subset of the first portion of the plurality of users respectively associated with the set of control devices, resulting in a first amount of sales of the product or service,
analyze the second set of digital images, including:
use the image recognition technique to identify at least one identifier included in each digital image of the second set of digital images, and
determine, from the at least one identifier included in each digital image of the second set of digital images, that the product or service was purchased, during the set period of time and subject to the digital promotion, by each of a subset of the remaining portion of the plurality of users respectively associated with the set of treatment devices, resulting in a second amount of sales of the product or service,
apply, to the account of each of the subset of the remaining portion of the plurality of users, the reward for purchasing the product or service,
apply, to the account of each of the subset of the first portion of the plurality of users, an additional reward for purchasing the product or service, wherein the additional reward is different from the reward,
determine, using the image recognition technique, (i) a third amount of sales of the product or service, among the first portion of the Plurality of users in the control group, that occurred in a defined time period prior to a start of the set period of time, and (ii) a fourth amount of sales of the product or service, among the remaining portion of the Plurality of users in the treatment group, that occurred in the defined time period prior to the start of the set period of time,
calculate an incremental lift percentage for the digital promotion, wherein the incremental lift percentage is the quantity one subtracted from the quotient of (i) the second amount of sales divided by the fourth amount of sales, divided by (ii) the first amount of sales divided by the third amount of sales,
calculate an amount of incremental sales for the digital promotion, wherein the amount of incremental sales is the second amount of sales minus the quotient of (i) the second amount of sales divided by (ii) the quantity one added to the incremental lift percentage,
calculate a verified incremental return for the digital promotion, wherein the verified incremental return is the quotient of the amount of incremental sales divided by a cost of the digital promotion, and
provide to a partner data source, a set of metrics comprising at least one of:
the amount of incremental sales or the verified incremental return, to enable the partner data source to review the set of metrics to at least one of: assess a set of key performance indicators (KPIs), assess the digital promotion, or strategize on a subsequent digital promotion.

10. (canceled)

11. The system of claim 9, wherein to segment the plurality of users, the one or more processors is configured to:
determine a holdout percentage of the plurality of users, and
segment the plurality of users into the control group that includes the first portion of the plurality of users according to the holdout percentage and the treatment group that includes the remaining portion of the plurality of users.

12-16. (canceled)

17. A non-transitory computer-readable storage medium configured to store instructions executable by one or more processors of a server computer, the instructions comprising:
instructions for retrieving, from a partner data source, promotion information specifying a reward associated with purchase of a product or service;
instructions for maintaining a listing of a plurality of users of an application facilitated by the server computer, wherein each user of the plurality of users has an account with the application;
instructions for segmenting the plurality of users into a control group that includes a first portion of the plurality of users and a treatment group that includes a remaining portion of the plurality of users, wherein a set of control devices is respectively associated with the first portion of the plurality of users and a set of treatment devices is respectively associated with the remaining portion of the plurality of users, and wherein the application facilitated by the server computer is operated by each of the set of control devices and each of the set of treatment devices;
instructions for providing, to each of the set of treatment devices, a digital promotion corresponding to the reward associated with the purchase of the product or service;
instructions for causing a user interface associated with the application operated by each of the set of treatment devices to (i) present the digital promotion in response to initiation of the application at each of the set of treatment devices, and (ii) avail, during a set period of time, the digital promotion, wherein the user interface indicates the reward associated with the purchase of the product or service, and wherein upon expiration of the set period of time, the user interface no longer avails the digital promotion;
instructions for causing the user interface associated with the application operated by each of the set of control devices to avail, during the set period of time, a set of additional digital promotions that does not include the digital promotion;
instructions for receiving, from at least a portion of the set of control devices, a first set of digital images depicting a first set of receipts and captured by an image sensor of each of at least the portion of the set of control devices, wherein the first set of digital images was captured in response to an initiation of a feature of the application operated by each of at least the portion of the set of control devices;
instructions for receiving, from at least a portion of the set of treatment devices, a second set of digital images depicting a second set of receipts and captured by an image sensor of each of at least the portion of the set of treatment devices, wherein the second set of digital images was captured in response to an initiation of the feature of the application operated by each of at least the portion of the set of treatment devices;
instructions for analyzing the first set of digital images, including:
instructions for using an image recognition technique to identify at least one identifier included in each digital image of the first set of digital images, and
instructions for determining, from the at least one identifier included in each digital image of the first set of digital images, that the product or service was purchased, during the set period of time, by each of a subset of the first portion of the plurality of users respectively associated with the set of control devices, resulting in a first amount of sales of the product or service;
instructions for analyzing the second set of digital images, including:
instructions for using the image recognition technique to identify at least one identifier included in each digital image of the second set of digital images, and
instructions for determining, from the at least one identifier included in each digital image of the second set of digital images, that the product or service was purchased, during the set period of time and subject to the digital promotion, by each of a subset of the remaining portion of the plurality of users respectively associated with the set of treatment devices, resulting in a second amount of sales of the product or service;
instructions for applying, to the account of each of the subset of the remaining portion of the plurality of users, the reward for purchasing the product or service;
instructions for applying, to the account of each of the subset of the first portion of the plurality of users, an additional reward for purchasing the product or service, wherein the additional reward is different from the reward;
instructions for determining, using the image recognition technique, (i) a third amount of sales of the product or service, among the first portion of the plurality of users in the control group, that occurred in a defined time period prior to a start of the set period of time, and (ii) a fourth amount of sales of the product or service, among the remaining portion of the plurality of users in the treatment group, that occurred in the defined time period prior to the start of the set period of time;
instructions for calculating an incremental lift percentage for the digital promotion, wherein the incremental lift percentage is the quantity one subtracted from the quotient of (i) the second amount of sales divided by the fourth amount of sales, divided by (ii) the first amount of sales divided by the third amount of sales;
instructions for calculating an amount of incremental sales for the digital promotion, wherein the amount of incremental sales is the second amount of sales minus the quotient of (i) the second amount of sales divided by (ii) the quantity one added to the incremental lift percentage;
instructions for calculating a verified incremental return for the digital promotion, wherein the verified incremental return is the quotient of the amount of incremental sales divided by a cost of the digital promotion; and
instructions for providing, to a partner data source, a set of metrics comprising at least one of: the amount of incremental sales or the verified incremental return, to enable the partner data source to review the set of metrics to at least one of: assess a set of key performance indicators (KPIs), assess the digital promotion, or strategize on a subsequent digital promotion.

18-20. (canceled)
